(19) United States
(12) Patent Application Publication
(10) Pub. No.: US 2004/0049666 A1
(43) Pub. Date: Mar. 11, 2004

(54) Method and apparatus for variable pop hardware return address stack

(76) Inventors: Murali M. Annavaram, Santa Clara, CA (US); Trung A. Diep, San Jose, CA (US); John Shen, San Jose, CA (US)

Correspondence Address: Dennis A. Nicholls, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/242,003

(22) Filed: Sep. 11, 2002

(51) Int. Cl. G06F 9/00

(52) U.S. Cl. 712/228; 712/242

(57) ABSTRACT

A system and method for correcting a hardware return address stack is disclosed. A set of digital comparators examines several locations near the top of the stack and compares them with a calculated return address. If a match is detected, the slot number corresponding to the match is overwritten into the hardware stack pointer register. The updated contents of the hardware stack pointer register may be a more accurate predictor of future returns from function calls.

### FIELD

The present disclosure relates generally to microprocessor systems, and more specifically to microprocessor systems capable of hardware stack operation.

### BACKGROUND

Many modern computer systems utilize instruction pipelines in an attempt to enhance the use of processor resources. Instructions are methodically fetched and decoded so that the execution units are not kept waiting for work to perform. However, if the wrong instructions are fetched, the pipeline will contain the wrong instructions and will therefore need to be flushed. Time spent in flushing and then re-filling the pipeline with valid instructions counts against performance. For this reason, most systems utilizing pipelines place emphasis on techniques that may successfully predict which instructions are to be executed in the future.

One form of prediction utilizes a hardware return address stack. Normally when executing a function call, the return address is placed at the top of (pushed onto) a software-maintained stack. Then when leaving the function that was called, the previously-stored return address is removed from (popped off from) the software-maintained stack. However, to access the return address stored in a software-maintained stack requires fetching and decoding the return instruction, which can take several cycles. Instead of waiting for return instruction decoding, an additional hardware return address stack may be maintained within the computer to supply predicted return addresses for the purpose of instruction fetching prediction.

A problem in instruction fetching prediction may arise when a return bypasses the immediate parent function, and instead goes to a more remote ancestor function. In this case the return address taken from the top of the hardware return address stack is wrong and will result in a misprediction. Compounding this problem, even if subsequent returns are to their respective immediate parent functions, the hardware return address stack may now contain return addresses in the wrong order, resulting in several mispredictions. Naturally the software return address stack, being maintained by software, will contain the right subsequent return addresses but only after the execution of return instructions. These occur too late to be used as predictors of instruction fetches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a hardware return address stack, according to one embodiment.

FIG. 2 is a diagram of calling to and returning from function calls, according to one embodiment.

FIG. 3 is a diagram of a hardware return address stack, according to one embodiment of the present disclosure.

FIG. 4 is a schematic diagram showing a four way search, according to one embodiment of the present disclosure.

FIG. 5 is diagram of a hardware return address stack showing the resynchronized stack pointer register, according to one embodiment of the present disclosure.

FIG. 6 is flow chart showing the modification of a stack pointer register, according to one embodiment of the present disclosure.

### DETAILED DESCRIPTION

The following description describes techniques for modifying the operation of a hardware stack in a microprocessor system. The hardware stack may in this manner be used to more accurately predict future instruction execution within an instruction pipeline. In the following description, numerous specific details such as logic implementations, software module allocation, bus signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. The invention is disclosed in the form of hardware within a microprocessor system. However, the invention may be practiced in other forms of processor such as a digital signal processor, or with computers containing a processor, such as a minicomputer or a mainframe computer.

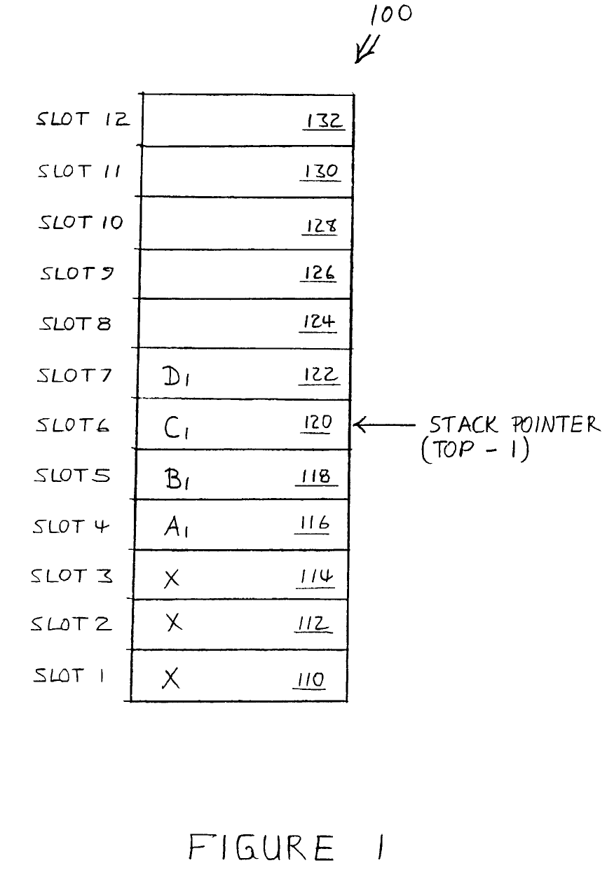

Referring now to FIG. 1, a diagram of a hardware return address stack 100 is shown, according to one embodiment. In other embodiments, the hardware stack may contain other data than merely return addresses for function calls. Hardware return address stack 100 contains numerous locations, or “slots”, whose contents may be return addresses. In one embodiment, the slots may be sequentially numbered from the bottom as shown. In other embodiments, the slots may be numbered differently. Hardware return address stack 100 may be written to in order beginning at slot 1 110 and ending at slot 12 132. In other embodiments the ordering may be reversed. In typical embodiments there may be many more or fewer slots than shown in FIG. 1, which shows a limited number of slots for clarity.

As an example of the operation of hardware return address stack 100, consider five functions A, B, C, D, and E. Function A may call function B and leave return address A₁, which may be placed in available slot 4 116. At a later time, function B may call function C and leave return address B₁, which may be placed in available slot 5 118. In turn, function C may call function D and leave return address C₁, which may be placed in available slot 6 120. Finally, function D may call function E and leave return address D₁, which may be placed in available slot 7 122. In each case the return address is placed in the next-highest slot that does not yet contain a valid return address, or when the stack is full the oldest entry is replaced. The slot that does contain the most recently placed valid return address is referred to as the top of the stack. When each function returns to the function that called it, the contents of the current top of the stack may be removed and used as a predictor of the next instruction to be fetched into the pipeline.

In order to keep track of the current location of the top of the stack, a return address stack pointer register may be used. This register may contain the slot number corresponding to the top of the stack: in other words, the slot number corresponding to the slot that contains the most recently pushed valid return address. In some embodiments, “corresponding” may mean equaling the slot number plus or minus a fixed offset. In these embodiments the fixed offset may be chosen for simplification of circuit design. The FIG. 1 embodiment shows an example where the stack pointer register contains slot number 6, where the top of the stack is slot number 7. In some embodiments, the contents of the stack pointer register are automatically modulo incremented when adding a new return address to the top of the stack and automatically modulo decrementing when removing a return address from the top of the stack.

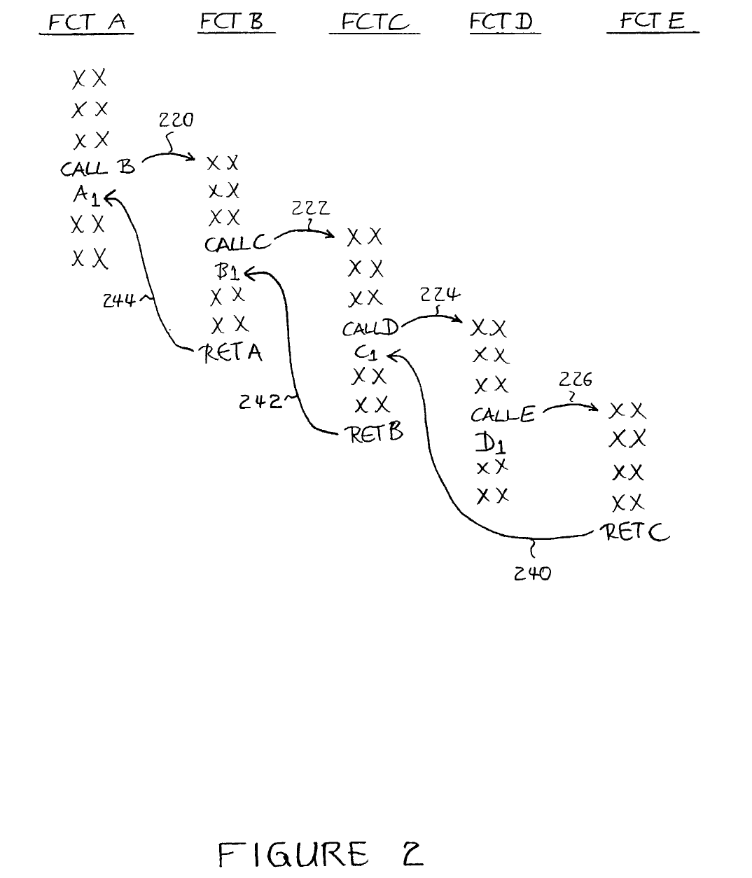

Referring now to FIG. 2, a diagram of calling to and returning from function calls is shown, according to one embodiment. Functions FCT A through FCT E may call one another in sequence. FCT A may execute until it executes a CALL B to FCT B 220, at which time the return address A₁ is placed at the top of the hardware return address stack. Then FCT B may execute until it executes a CALL C to FCT C 222, at which time the return address B₁ is placed at the top of the hardware return address stack. Then FCT C may execute until it executes a CALL D to FCT D 224, at which time the return address C₁ is placed at the top of the hardware return address stack. Finally, FCT D may execute until it executes a CALL E to FCT E 226, at which time the return address D₁ is placed at the top of the hardware return address stack.

After FCT E is through executing, it may return to the function that called it (called the “parent” function), FCT D. In this case, the top of the hardware return address stack contains the correct return address, D₁. Using the value contained at the top of the hardware return address stack to predict those instructions for fetching will in this case result in a correct prediction.

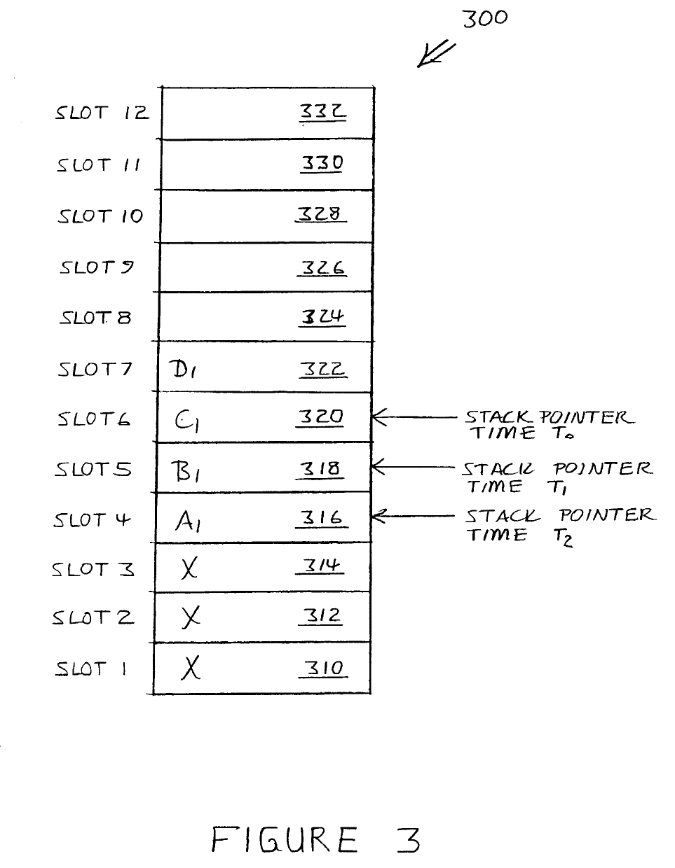

However, many times a function will not necessarily return to the parent function. Instead it may return to a previous function, called an ancestor function. In the FIG. 2 example, FCT E determines that the return should be to the ancestor FCT C rather than to the parent FCT D. FCT E then executes a RET C to FCT C 240, intending to resume execution at return address C₁. But here C₁ is not at the top of the hardware return address stack. The contents popped from the top of the hardware return address stack, D₁, will cause a misprediction to occur. This may necessitate that the pipeline be flushed, thereby incurring a performance penalty. Furthermore, the stack pointer register will in the future contain the wrong values, as discussed below in connection with FIG. 3.

Referring now to FIG. 3, a diagram of a hardware return address stack 300, according to one embodiment of the present disclosure. The hardware return address stack 300 is generally similar to that shown in FIG. 1, and the contents of hardware return address stack 300 relate to the chain of function calls of FIG. 2. At a first time T₀, the function FCT E is executing and ends by performing a RET C 240. However, the stack pointer register at time T₀ contains a value corresponding to slot 7 322, containing D₁. Therefore an instruction fetch prediction made by using D₁ will cause a misprediction.

When the contents D₁ of slot 7 322 are retrieved, the stack pointer register is decremented. Thus when FCT C is again executing at time T₁, the stack pointer register at time T₁ contains a value corresponding to slot 6 320, containing C₁. When FCT C executes a RTN B 242, the value C₁ will be returned from the hardware return address stack and again cause a misprediction. When the contents C₁ of slot 6 320 are retrieved, the stack pointer register is again decremented. Thus when FCT B is again executing at time T₂, the stack pointer register at time T₂ contains a value corresponding to slot 5 318, containing B₁. When FCT B executes a RTN A 244, the value B₁ will be returned from the hardware return address stack and yet again cause a misprediction.

Thus, once a first return is made to a non-parent ancestor function, the subsequent use of a hardware return address stack as an accurate predictor for fetching instructions may be compromised. Once the stack pointer register contains a value corresponding to a slot address containing the wrong return address, it may continue, through the process of decrementing, to contain values corresponding to slot addresses containing wrong return addresses. Therefore, in one embodiment of the present invention, the stack pointer register may be resynchronized to the proper return addresses in order that future predictions made using return addresses from the hardware return address stack may be correct.

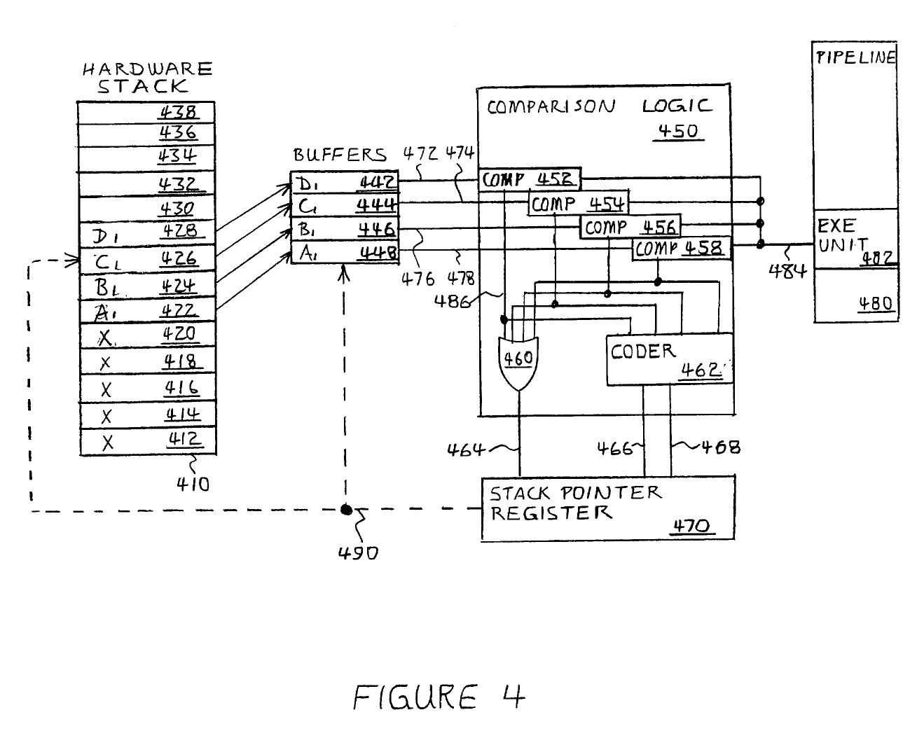

Referring now to FIG. 4, a schematic diagram shows a four way search, according to one embodiment of the present disclosure. In other embodiments, fewer or greater than four entries may be examined. The hardware stack 410 may have its top of stack location tracked by stack pointer register 470. Stack pointer register 470 may increment or decrement by one whenever a return address is pushed onto or popped from the hardware stack 410. However the contents of stack pointer register 470 may also be modified responsive to a four way search.

In the FIG. 4 example, buffers 442, 444, 446, 448 may be loaded with the contents of the four slot locations at the top of hardware stack 410. The time at which the buffers are loaded may be immediately prior to taking the value at the top of the stack to use as an instruction fetch predictor. Buffers 442, 444, 446, 448 may determine which particular slots are at the top of the stack by using stack pointer register 470. The contents of buffers 442, 444, 446, 448 may each be later compared with the eventual calculated return address to determine whether one of the four contents would have correctly predicted the eventual calculated return address. In one embodiment, a comparison logic 450 includes four digital comparators 452, 454, 456, 458 that have one input connected to buffers 442, 444, 446, 448, respectively, and the other input connected to a calculated return address signal 484 supplied by an execution unit 482 of an instruction pipeline 480. In other embodiments, other forms of comparison logic may be implemented. The outputs of digital comparators 452, 454, 456, 458 may be coupled to an OR gate 460 and a coder 462. If a match is detected between the calculated return address and one of the contents of buffers 442, 444, 446, 448, a match signal 464 may be generated by OR gate 460. Also the relative slot number of the slot whose contents match the calculated return address may be generated over slot number signals 466, 468 from coder 462. In other embodiments, the presence of a match, if any, may be determined in a different manner, and the presence of a match may be signaled to the stack pointer using differing kinds of signals.

Stack pointer register 470 may be configured with modification logic to modify its contents when it receives the match signal 464 and relative slot number signals 466, 468. In one example, if the contents of buffer 442 are a match with the calculated return address, then the previous use of the contents of buffer 442 correctly predicted the eventual calculated return address, and no further modifications beyond the regular decrement of stack pointer register 470 are needed. In another example, if the contents of buffer 444 are a match with the calculated return address, then the previous use of the contents of buffer 442 did not correctly predict the eventual calculated return address. The contents of stack pointer register 470 may be reduced further by one to resynchronize the hardware stack 410 on the basis of the calculated return address. In a third example, if the contents of buffer 446 are a match with the calculated return address, then the previous use of the contents of buffer 442 did not correctly predict the eventual calculated return address. The contents of stack pointer register 470 may be reduced further by two to resynchronize the hardware stack 410 on the basis of the calculated return address. Finally, in a fourth example, if the contents of buffer 448 are a match with the calculated return address, then the previous use of the contents of buffer 442 did not correctly predict the eventual calculated return address. The contents of stack pointer register 470 may be reduced by three to resynchronize the hardware stack 410 on the basis of the calculated return address. In each of the above examples where the previous use of the contents of buffer 442 did not correctly predict the eventual calculated return address, the use of the comparison logic 450 may resynchronize the contents of the stack pointer register 470 to allow correct instruction fetch predictions for subsequent return operations.

In other embodiments, buffers 442, 444, 446, 448 may be eliminated and the contents of slots in hardware stack 410 may be directly supplied to comparison logic 450. Similarly the OR gate 460 and coder 462 may be replaced by other circuits to signal the existence of a match, and the matching relative slot number. More or fewer than four slot contents at the top of the hardware stack 410 may be compared with the calculated return address. In special circumstances where there may be more than one slot number whose contents match the calculated return address, one embodiment may disable the match signal 464. Another embodiment may have coder 462 return the highest relative slot number whose contents match the calculated return address.

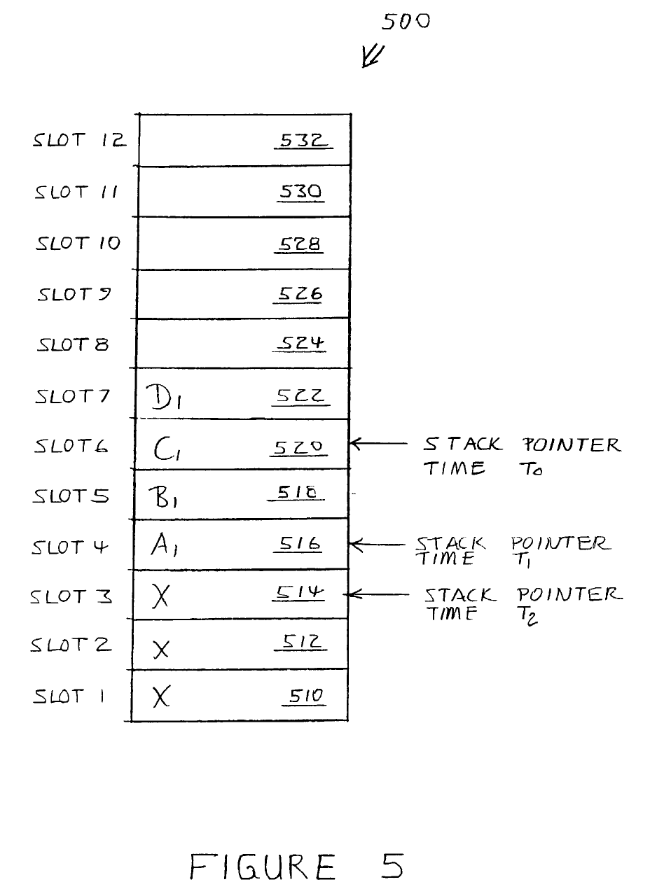

Referring now to FIG. 5, a diagram of a hardware return address stack 500 shows the resynchronized stack pointer register, according to one embodiment of the present disclosure. The FIG. 5 diagram corresponds to the scenario of system calls shown in FIG. 2, but utilizing an apparatus generally similar to that shown in FIG. 4. At a first time T₀, the function FCT E is executing and ends by performing a RET C 240. However, the stack pointer register at time T₀ contains a value corresponding to slot 7 522, containing D₁. Therefore an instruction fetch prediction made previously by using D₁ will cause a misprediction.

When the contents D₁ of slot 7 522 are retrieved to use in the instruction fetch prediction mentioned above, the stack pointer register is decremented. However, at this same time the contents D₁ of slot 7 522, C₁ of slot 6 520, B₁ of slot 5 518, and A₁ of slot 4 516 are presented to the comparison logic. When the RET C 240 instruction is performed, a calculated return address value of C1 is determined. The comparison logic will detect a match between this calculated return address and the contents of slot 6 520, rather than the expected slot 7 522. This condition will give rise to a true signal on the match signal and will give a relative slot number of one below the top of the stack. Using this knowledge, the stack pointer register has an additional value of one subtracted from the decremented value. Thus when FCT C is again executing at time T₁, the stack pointer register at time T₁ contains a value corresponding to slot 5 518, containing B₁. When FCT C prepares to execute a RTN B 242, the value B₁ will be returned from the hardware return address stack and may be used to successfully predict an instruction fetch.

When the contents B₁ of slot 5 518 are retrieved to use in the instruction fetch prediction mentioned above, the stack pointer register is decremented. At this same time the contents B₁ of slot 5 518, A₁ of slot 4 516, X of slot 3 514, and X of slot 2 512 (the top four slots on the hardware stack) are presented to the comparison logic. When the RET B 242 instruction is performed, a calculated return address value of B1 is determined. The comparison logic will detect a match between this calculated return address and the contents of slot 5 518, located at the current top of the hardware stack. This condition will give rise to a true signal on the match signal and will give a relative slot number of zero below the top of the stack. Using this knowledge, the stack pointer register retains unmodified the recently decremented value. Thus when FCT B is again executing at time T₂, the stack pointer register at time T₂ contains a value corresponding to slot 4 516, containing A₁. When FCT B prepares to execute a RTN A 244, the value A₁ will be returned from the hardware return address stack and may be used to again successfully predict an instruction fetch. If a new return instruction is fetched, while a previous return instruction is pending execution, one may use multiple sets of buffers to store the top entries of return address stack for simultaneous comparisons.

In the FIG. 5 example, an initial instruction fetch misprediction when using the values stored within a hardware return address stack did not give rise to subsequent instruction fetch mispredictions. The utilization of a circuit generally similar to that of FIG. 4 has effected a resynchronization of the contents of the stack pointer register with the hardware return address stack.

Although the example of FIG. 2, as examined in the FIG. 5 example, used only function calls, other changes between portions of software code could utilize the hardware return address stack. In one embodiment, interrupts causing a function to jump to an interrupt service routine (ISR) may have return addresses stored in a hardware return address stack, and in some embodiments these may be interleaved with function call return addresses. In either embodiment circuits generally similar to that shown in FIG. 4 may resynchronize of the contents the stack pointer register with the hardware return address stack. In other embodiments, switching between threads may be facilitated using a hardware return address stack of the present disclosure.

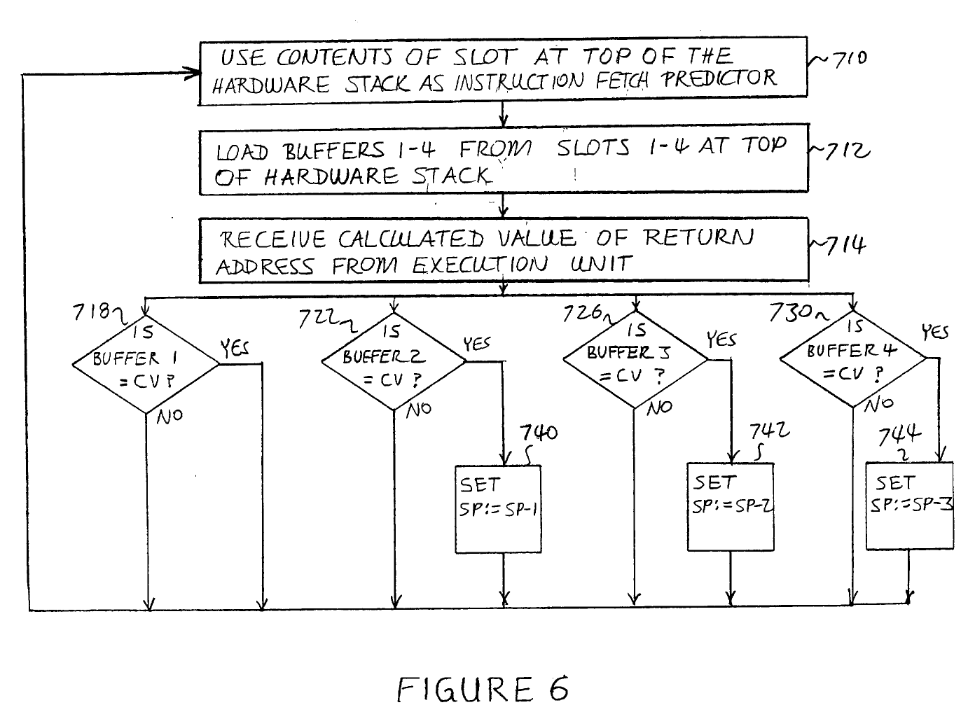

Referring now to FIG. 6, a flow chart shows the modification of a stack pointer register, according to one embodiment of the present disclosure. The flow chart of FIG. 6 presupposes the returning from a long series of system calls previously made. In the first block, 710, a return address is pulled from the slot at the top of the hardware stack and used as an instruction fetch predictor. Then in block 712, the contents of slots with relative slot numbers 1 through 4 at the top of the hardware stack are moved into buffers 1 through 4, respectively, and the stack pointer register is decremented. In other embodiments, the contents of more or fewer than 4 slots may be moved, and in other embodiments the contents of slots may be examined without the intermediate buffer stage. Then at a later time, in block 714, the actual, calculated return address value is received from the execution unit. A series of parallel decision blocks, 718, 722, 726, and 730, then compare the contents of buffers 1 through 4 with the calculated value. In other embodiments, the comparisons may be performed sequentially. If no match is made in any of the decision blocks 718, 722, 726, and 730, no further operations are performed and the process returns to block 710.

If, in decision block 718, the contents of buffer 1 match the calculated value, then decision block 718 exits via the YES branch but simply returns to block 710. If, in decision block 722, the contents of buffer 2 match the calculated value, then decision block 722 exits via the YES branch and in block 740 the current value SP of the stack pointer register is replaced by (SP-1). If, in decision block 726, the contents of buffer 3 match the calculated value, then decision block 726 exits via the YES branch, and in block 742 the current value SP of the stack pointer register is replaced by (SP-2). If, in decision block 730, the contents of buffer 4 match the calculated value, then decision block 730 exits via the YES branch, and in block 744 the current value SP of the stack pointer register is replaced by (SP-3). In each case, the current value SP of the stack pointer register is replaced by a new value that may resynchronize the stack pointer register with the hardware return address stack. Subsequent to such a replacement, the process returns to block 710.

There are other embodiments of the method than the one discussed in detail above. In one possible embodiment, a series of normal POP operations may be performed sequentially on the hardware stack until a match occurs. After reaching a limit of POPs, such as the quantity 4 of the above example, if no match occurs then the hardware stack may be restored by using an equal number of PUSH operations, using saved values POPed from the hardware stack.

In another possible embodiment, the hardware stack may be implemented using hardware first-in first-out (FIFO) registers. In this embodiment a stack pointer may not be necessary because the values within the hardware stack may move up and down physically within the hardware stack. A stack pointer may not be needed because the value at the “top of the stack” may always be in the physical location at the top of the stack. In this case the comparisons of values are performed in order to seek a match, but stack pointer modifications are not performed. Instead the values at the top of the stack are removed until the matching value is present at the top of the physical stack.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. An apparatus, comprising:
a hardware stack including a plurality of slots each having a unique slot number;
a stack pointer register coupled to said hardware stack; and
a comparison logic to convey a slot number to said stack pointer register corresponding to one of said slots if contents of said one of said slots matches a calculated return address.

2. The apparatus of claim 1, wherein said comparison logic sends a match signal if a match is detected between contents of any of said slots and said calculated return address.

3. The apparatus of claim 1, wherein an element of said comparison logic is coupled to one of said plurality of slots located at top n locations in said hardware stack.

4. The apparatus of claim 3, wherein said stack pointer register includes modification logic to change a value of said stack pointer register.

5. The apparatus of claim 3, wherein contents of said one of said plurality of slots located at top n locations in said hardware stack is loaded into buffers.

6. The apparatus of claim 5, wherein said buffers are coupled to said comparison logic.

7. The apparatus of claim 1, wherein said calculated return address is supplied from an execution unit in an instruction pipeline.

8. The apparatus of claim 1, wherein contents of said stack pointer register are modified responsive to said one of said slot numbers.

9. A method, comprising:
receiving a calculated value of a return address;
comparing said calculated value to contents of n slots at top of a hardware stack; and
modifying contents of a register if a match exists between said calculated value and contents of one of said n slots.

10. The method of claim 9, wherein said modifying includes changing contents of said register to correspond to a slot number of said one of said n slots if a match exists between said calculated value and contents of said one of said n slots.

11. The method of claim 10, wherein said register is a stack pointer register.

12. The method of claim 11, further comprising signaling said stack pointer register if a match exists between said calculated value and contents of said one of said n slots.

13. The method of claim 11, further comprising signaling said slot number to said stack pointer register.

14. The method of claim 9, further comprising loading a set of buffers with contents of said n slots.

15. An apparatus, comprising:
means for receiving a calculated value of a return address;
means for comparing said calculated value to contents of n slots at top of a hardware stack; and
means for modifying contents of a register if a match exists between said calculated value and contents of one of said n slots.

16. The apparatus of claim 15, wherein said means for modifying includes means for changing contents of said register to correspond to a slot number of said one of said n slots if a match exists between said calculated value and contents of said one of said n slots.

17. The apparatus of claim 16, wherein said register is a stack pointer register.

18. The apparatus of claim 17, further comprising means for signaling said stack pointer register if a match exists between said calculated value and contents of said one of said n slots.

19. The apparatus of claim 17, further comprising means for signaling said slot number to said stack pointer register.

20. The apparatus of claim 15, further comprising means for loading a set of buffers with contents of said n slots.

21. The apparatus of claim 16, wherein said register is a first-in first-out register within said hardware stack.
